(19) United States
(12) Patent Application Publication
(10) Pub. No.: US 2022/0258760 A1
(43) Pub. Date: Aug. 18, 2022

(54) Rearview System for a Vehicle with Collision Detection

(71) Applicant: Atlis Motor Vehicles, Inc., Mesa, AZ (US)

(72) Inventors: Benoit le Bourgeois, Mesa, AZ (US); Christopher Dawson, Mesa, AZ (US); Mark Hanchett, Mesa, AZ (US)

(73) Assignee: Atlis Motor Vehicles, Inc., Mesa, AZ (US)

(21) Appl. No.: 17/580,120

(22) Filed: Jan. 20, 2022

Related U.S. Application Data
(60) Provisional application No. 63/146,004, filed on Feb. 5, 2021.

(51) Int. Cl. B60W 50/16; G08G 1/16; B60W 30/095; B60Q 3/16; B60Q 3/14; B60R 1/04

(52) U.S. Cl. CPC B60W 50/16; G08G 1/166; B60W 30/095; B60W 2050/146; B60Q 3/14; B60R 1/04; B60Q 3/16

(57) ABSTRACT

In an embodiment, a rearview system detects the present and information regarding one or more second vehicles. The system uses the information regarding the second vehicles to determine whether a collision may occur. In the event of a predictive collision, the system provides the user a warning. In another embodiment, the rearview system presents video data having different fields-of-capture. In another embodiment, the system includes a user interface that includes a display and a haptic pad. The display presents information. The haptic pad enables the user to provide information to the system. A location on the haptic pad corresponds to a location on the display. The user may manipulate the haptic pad to activate icons presented on the display.

### BACKGROUND

Embodiments of the present invention relate to vehicles.

A vehicle, including electric vehicles, include systems (e.g., motors, drive train, environmental, infotainment) that provide information to and receive instructions (e.g., commands) from a user. The systems provide information to the user via instruments and/or a display. The user provides instructions to the systems via a user interface that includes controls (e.g., buttons, knobs, levers, touchscreen). The displays and the user interface is located on or near the dashboard of the vehicle. Vehicles may benefit from a haptic pad that enables the user to provide instructions to the systems. Users may benefit from a display that highlights information in accordance with safety.

### SUMMARY

Some of the various embodiments of the present disclosure relate to the instrumentation (e.g., display) in a vehicle that provides information to the user of the vehicle regarding the operation of the vehicle. Some of the various embodiments of the present disclosure further relate to a user interface (e.g., haptic pad) that physically maps (e.g., relates) to the instrumentation (e.g., display) to enable the user to provide instructions to the vehicle. Information related to the systems of a vehicle may be presented on one or more displays for viewing by the user of the vehicle. The information from the systems the vehicle may be formatted as one or more system cards. A system card is presented on a display to provide information to the user.

A system card may further include icons that are also presented to the user on the display. The user may use the haptic pads to manipulate the icons. Manipulating an icon sends a system instruction to one or more of the systems. The system instruction includes information as to how the system should operate. Manipulating an icon may be accomplished by manipulating a portion of the haptic pad. The icon is presented on a portion of the display. Because the surface area of the haptic pad relates to the area of the display, a portion of the haptic pad relates to the portion of the display where the icon is presented. Manipulating the portion of haptic pad that relates to the portion of the display where the icon is presented, manipulates the icon. Manipulating the haptic pad includes touching the haptic pad. Touching the haptic pad may be accomplished by using one or more of a plurality of different types of touches (e.g., single touch, double touch, swipe).

In another example embodiment of the present disclosure, a rearview system detects one or more second vehicles behind the vehicle. A processing circuit uses the information detected regarding the one or more second vehicles to determine whether it is likely that a collision will occur between the vehicle and one or more of the second vehicles. In the event of a collision, the processing circuit is adapted to present a warning to the user on one or more displays.

In another example embodiment of the present disclosure, a rearview camera captures video data having a narrow-angle field-of-capture and a wide-angle field-of-capture. The video data having the narrow-angle field-of-capture is presented on a first portion of the display, while the video data having the wide-angle field-of-capture is presented on a second portion of the display.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is front view of an example embodiment of a vehicle according to various aspects of the present disclosure.

FIG. 2 is view of an interior of the vehicle of FIG. 1.

FIG. 3 is an example embodiment of a user interface according to various aspects of the present disclosure.

FIG. 4 is a diagram of the systems of the vehicle of FIG. 1 and the system cards for displaying information regarding the systems and receiving information from a user to control the systems.

FIG. 5 is a diagram of an example embodiment of a system card for the power system of an electric version of the vehicle of FIG. 1.

FIG. 6 is a diagram of an example embodiment of a system card for the environmental system of the vehicle of FIG. 1.

FIGS. 7-9 are diagrams of example embodiments of system cards for the infotainment system of the vehicle of FIG. 1.

FIG. 10 is a diagram of an example embodiment of a user interface and a rearview system of the vehicle of FIG. 1.

FIGS. 11-12 are diagrams of example embodiment of selecting system cards for presentation on one or more displays.

FIG. 13 is a diagram of the vehicle for capturing rearview video data including video data having different fields-of-view.

FIGS. 14 and 15 are diagrams of the vehicle with a plurality a second vehicles behind the vehicle.

FIG. 16 is a diagram of a display presenting information regarding second vehicles rearward of the vehicle and a first implementation of a warning regarding a possible collision.

FIG. 17 is a diagram of a display presenting information regarding second vehicles rearward of the vehicle and a second implementation of a warning regarding a possible collision.

FIG. 18 is a diagram of a display presenting information regarding second vehicles rearward of the vehicle and a third implementation of a warning regarding a possible collision.

FIG. 19 is a diagram of a display presenting narrow-angle field-of-view and wide-angle field-of-view video data.

### DETAILED DESCRIPTION

### Overview

An example embodiment of the present disclosure relates to vehicles, including electric vehicles. A vehicle has a plurality of systems (e.g., battery, environment, infotainment, engine, motor). Each system performs a function. The systems cooperate to enable the vehicle to operate. Each system provides information (e.g., data) regarding the operation of the system. The data may be used to determine how well the system is operating. Further, some systems may receive input from a user to control (e.g., start, stop, increase, decrease, pause) the operation of the system. A user interface may be used to provide a user information regarding the operation of the various systems and to allow the user to provide instructions to control the various systems.

In an example embodiment, the user interface includes one or more displays, one or more haptic pads and a processing circuit. The area of the display corresponds to the surface area of the haptic pad. Each location where a user may touch the haptic pad corresponds to a location on the display. An icon presented at a location on the display may be manipulated by touching the corresponding location of the haptic pad. Accordingly, a user may interact with the information presented on the display using the haptic pad.

The information from the systems is organized into what are referred to as system cards. A system card organizes system information for presentation on the display. The information from a single system may be displayed as one or more system cards. A system card may include zero or more icons. The icons on a system card may be manipulated via the haptic pad to provide instructions to a system to control the system. To manipulate an icon presented on the system card, the user determines the location of the icon on the display and touches the haptic pad at the corresponding location on the haptic pad. Different touching gestures may be made on the haptic pad to emulate pressing an icon represented as a button, toggling an icon represented as a toggle switch, or slidingly moving an icon represented as a sliding knob (e.g., slider).

In another example embodiment, the user interface includes a first display, a second display, a first haptic pad, a second haptic pad, and a processing circuit. The area of the first display corresponds to the surface area of the first haptic pad. The area of the second display corresponds to the surface area of the second haptic pad. Information from systems organized as system cards may be presented on either the first or the second display. Icons presented on the first display may be manipulated by touching the first haptic pad. Icons presented on the second display may be manipulated by touching the second haptic pad.

Another example embodiment of the present disclosure relates to a rearview system that includes collision detection and/or different fields-of-view. The rearview system includes a detector, one or more cameras, one or more displays and a processing circuit.

Vehicle Systems, System Information and System Instructions

A vehicle has a plurality of systems. An electric vehicle may have some systems that are different from the systems of an internal combustion engine (“ICE”) or that perform different or additional functions. The systems of the vehicle cooperate with each other to enable the vehicle to move and operate. The systems of the vehicle may include a power system (ICE, electric motor) 412/414, a transmission system 416, a battery system 418, an environmental system 420, an infotainment system 422, a motion system 424, a cruise control system 426, a lighting system 428, a communication system 430, and a braking system 432.

A system may report information regarding its own operation. A system may receive instructions (e.g., commands) that affect (e.g., change, alter) the operation of the system. A user interface may be used as the interface between the systems and a user of the vehicle. The information reported by the systems may be presented to the user via the user interface. The user may provide the instructions that affect the operation of a system via the user interface. For example, Table 1 below identifies the information that may be provided by a system for presentation to user and the instructions that may be provided by a user and sent to a system.

TABLE 1
System Information and Instructions

| ID | System | Information Provided | Instructions Received |
|---|---|---|---|
| 412 | Power | oil level, | RPMs (via gas pedal) |
| | (ICE) | oil pressure, | |
| | | temperature, | |
| | | coolant level, | |
| | | RPMs, | |
| | | hours operated, | |
| | | fuel consumption, | |
| | | torque generated, and | |
| | | engine load | |
| 414 | Power | temperature, | RPMs (via gas pedal) |
| | (Electric) | RPMs, | |
| | | hours operated, | |
| | | power in, | |
| | | torque out, and | |
| | | slip | |
| 416 | Trans- | temperature, | mode (automatic, via selector), |
| | mission | fluid level, | gear (manual, via stick) |
| | | mode 318 (auto: PRNDL), | |
| | | gear (manual, 1-6, R), and | |
| | | gear ratio | |
| 418 | Battery | output current, | |
| | | output voltage, | |
| | | temperature, | |
| | | remaining charge, | |
| | | time to depletion, and | |
| | | time to full charge | |
| 420 | Environ- | outside temperature 312, | fan speed, |
| | mental | inside temperature, | desired temperature, |
| | | fan speed, | vent (open/close), |
| | | vent status, and | seat heating (on/off) |
| | | seat heating status | |
| 422 | Info- | volume level, | volume (0-100), |
| | tainment | fade, | fade (front/back), |
| | | balance, | balance (right/left), |
| | | speed sensitive volume, | speed sensitive (on/off), |
| | | source, | source (USB/radio/DVD), |
| | | radio channel, | radio channel (select |
| | | equalizer ranges, | frequency), equalizer (set |
| | | seek, | ranges), seek (up/down), |
| | | saved channels, and | save channels (save/goto), |
| | | AM/FM | AM/FM (select) |
| 424 | Motion | miles (odometer) 316, | trip (reset), |
| | | trip (trip meter), | time (set), |
| | | speed (speedometer) 320, | date (set) |
| | | direction (compass), | |
| | | time of day 300, and | |
| | | date | |
| 426 | Cruise | status (on/off/speed) | enable (on/off), |
| | Control | | set (on/off/set/incr/decr/cancel) |
| 428 | Lighting | driver map light status, | driver map light (on/off), |
| | | passenger map light | passenger map light (on/off), |
| | | status, dome light status, | dome light (on/off), |
| | | head lights status, | head lights (on/off/auto/bright), |
| | | bright beam status 314, | fog light (on/off), |
| | | fog light status, and | emergency lights (on/off) |
| | | emergency lights | |
| 430 | Commu- | directory, | directory (select/up/down), |
| | nication | most recent, | most recent (select/up/down), |
| | (e.g., | call status, | call status (dial, ans, discon) |
| | cell | incoming call information, | |
| | phone) | and | |
| | | signal strength, | |
| | | battery level | |
| 432 | Braking | fluid levels (normal/low), | engage (via brake pedal). |
| | | temperature, | |
| | | wear, | |
| | | slip, and | |
| | | fade | |

Information from the various systems may be organized for presentation to the user. The information presented to user may be organized to present information from a single system or combination of information from a variety of systems. Information from the various systems may be organized for presentation on the display (e.g., CRT, LED, plasma, OLED, touch screen). The information may be presented on one display or multiple displays. The information presented regarding the system may include icons. Icons may be used to enable a user to provide an instruction to a system. An icon may be manipulated by a user to send information to a system to affect the operation of the system.

### Single Display, Single Haptic Pad User Interface

In an example embodiment, a user interface for presenting information to user and for receiving instructions from the user includes a display (e.g., 140), a processing circuit (e.g., 1010), a memory (e.g., 1020), and a haptic pad (e.g., 210). The processing circuit receives system information from and/or provides system instructions to the power system 412/414, the transmission system 416, and the other systems identified in Table 1 above.

The haptic pad includes such implementations as a haptic trackpad, a haptic touchpad, and a pressure-sensing surface. The haptic pad is configured to detect a touch by a user when the user touches a surface of the haptic pad. The user may touch the haptic pad in a variety of manners or use a variety of gestures. A user may touch a portion of the haptic pad and release the touch (e.g., tap, press) to contact a single point on the touchpad. A user may touch a portion of the haptic pad and hold the touch prior to releasing the touch (e.g., touch and hold). The user may touch a portion of the haptic pad then while maintaining the touch (e.g., maintaining contact with the surface of the haptic pad) draw the touch across the haptic pad (e.g., swipe) before releasing the touch. The user may touch a portion haptic pad then while maintaining the touch draw the touch across the haptic pad in a first direction then in a second direction (e.g., shaped swipe) prior to releasing the touch. The haptic pad detects the one or more portions (e.g., locations) of the haptic pad touched by the user between the start of the touch and the release of the touch. A user may touch the haptic pad using their finger or within instrument (e.g., stylus, stylus pen).

The haptic pad is configured to provide a touch information that includes a description of a portion of the haptic pad touched by the user. The touch information identifies each portion of the touchpad touched (e.g., contacted) by the user between a start of the touch and a release of the touch. The touch information may identify a single location for a touch that does not move between the start of the touch and the end of the touch (e.g., tap, press). The touch information may identify all locations where the haptic pad was touched at the start of touch, after the start, and the location where the touch was released (e.g., swipe, shaped swipe). The touch information may identify a duration of a touch (e.g., touch and hold), a length of a swipe, and amount of pressure of a touch, a speed of a swipe, and/or a direction of a swipe.

The haptic pad may provide the touch information to the processing circuit. The haptic pad may provide the touch information in any suitable format (e.g., digital, analog, x-y coordinates, polar coordinates). In an example embodiment, the haptic pad (e.g., 210, 220) provides the touch information to the processing circuit 1010.

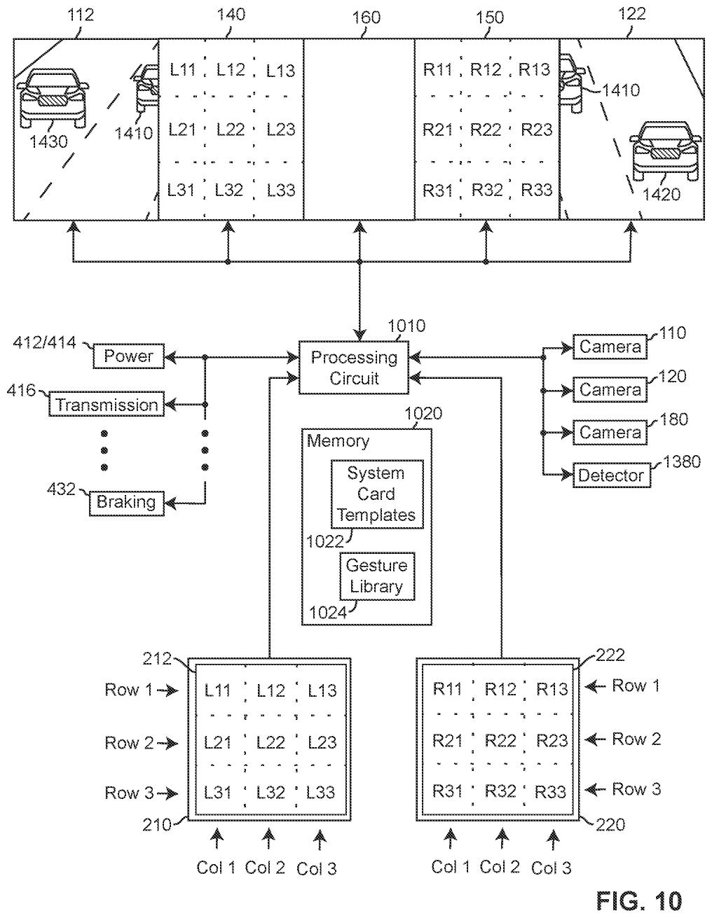

In an example implementation, the portions (e.g., locations) on the haptic pad may be described as having a particular size or shape (e.g., granularity). A haptic pad that has a low granularity has portions that are large in size and few total portions over the surface area of the haptic pad. A haptic pad that has a high granularity has portions that are small in size and several if not many total portions. In an example embodiment, best shown in FIG. 10, haptic pad 210 is divided to have three rows and three columns thereby providing a granularity of nine squares (e.g., portions, locations). In this example, the squares of the haptic pad 210 are identified as belonging to a row and a column (e.g., L11, L21, so forth, R11, R21, so forth). With reference to FIG. 10, the squares of haptic pad 210, positioned toward the left in the figure, are identified as L11, L12, and so forth where the letter “L” stands for “left”. The squares of haptic pad 220, positioned toward the right in the figure, are identified as R11, R12, and so forth where the letter “R” stands for “right”.

With a granularity of nine, a touch or swipe confined to the area of a single square, for example L31, may be reported by the haptic pad 210, in the touch information, as a single touch to a single location, in this example L31. A touch that begins in one square and ends in another square will be reported in the touch information as a swipe that starts in the first square touched and ends in the square where the touch is released. For example, a touch that starts in square R11 and is swiped diagonally through squares R22 and is released in square R33 will be reported by the haptic pad 220, in the touch information, as a swipe through all three squares with a starting point in square R11 and an ending point in square R33.

A haptic pad may have any granularity which means it may detect touches and swipes beginning, ending and through any number of portions (e.g., squares) of the haptic pad. A haptic pad may have a multitude of sensors (e.g., capacitive sensors) or sensors at the corners of the pad that provide a high granularity.

In an example embodiment, the touch information may identify the touch in a high granularity, yet the granularity used to interpret the touch may be determined by the processing circuit. For example, capacitive haptic pad may have 512×512 capacitive sensors or a corner sensor haptic pad may detect a touch to within a millimeter of the location of the touch, yet the processing circuit may convert the touch information provided by the haptic pad into any number of rows and columns that is equal to or less than the resolution of the haptic pad. In an example embodiment, the haptic pad 210 has a high resolution (e.g., high granularity), yet the processing circuit 1010 converts the touch information provided by the haptic pad 210 to correspond to a grid of three rows and three columns.

The haptic pad (e.g., 210, 220) may also detect and report a force of a touch, a speed of a swipe, a length of a swipe, and/or a shape of a swipe. The processing circuit (e.g., 1010) may use the force, the speed, the length and/or the shape information in any manner. A haptic pad that may detect and report force, speed, length and/or shape of a swipe may enable the user to use complex gestures to provide information.

The haptic pad (e.g., 210, 220) and the display (e.g., 140, 150 respectively) are configured so that a portion (e.g., location) on the haptic pad corresponds to a location on the display. The processing circuit (e.g., 1010) may correlate the touch information from the haptic pad to a location on the display. In an example implementation, best shown in FIG. 10, the haptic pad 210 is divided into three rows and three columns. The display 140 is similarly divided into three corresponding rows and columns. The processing circuit 1010 correlates a touch in a square (e.g., L11, L12, so forth) of the haptic pad 210 to a corresponding square (e.g., L11, L12, so forth respectively) of the display 140. A similar correspondence is established between the haptic pad 220 and the display 150.

The haptic pad does not need to be the same physical size as the display to correlate a portion haptic pad to apportion of the display. In an example embodiment, the surface area of the haptic pad 210 is about half the surface area of the display 140. However, the processing circuit 1010 divides the area of haptic pad 210 and the area of the display 140 into three corresponding rows and three corresponding columns. When the user touches a square on the haptic pad 210, for example L22, the processing circuit correlates the square on the haptic pad 210 to the corresponding square on the display 140, in this case L22, regardless of the size difference between the area of the square, or grid, on the haptic pad 210 and the area of the square, or grid, on the display 140.

### Introduction to System Cards and Icons

As discussed below, the correspondence between the haptic pad and the display enables the processing circuit 1010 to construe when the user has activated an icon. As further discussed below, and as best seen in FIG. 10, the processing circuit 1010 is configured to receive a system information from the one or more systems (e.g., 412-432) of the vehicle regarding the operation of the one or more systems. The processing circuit 1010 organizes the system information into a format that is referred to as system cards. The processing circuit 1010 presents the system cards (e.g., 500-900, SC01-SC07) on a display (e.g., 140, 150). There may be a plurality of system cards. One of the system cards (e.g., 500-900, SC01-SC07) may be presented on a display at a given time. The system information on a system card may pertain to a single system or may include information from two or more systems. More than one system card may be used to format and display the information from a single system (e.g., infotainment system 422). The processing circuit 1010 is configured to use the system information to form the one or more system cards for presenting on the display. The processing circuit 1010 is configured to provide the system card (e.g., 500-900, SC01-SC07) to the display for presenting to the user.

A system card may include an icon for controlling the one or more systems. A user may manipulate (e.g., activate, select, highlight, adjust) an icon via a haptic pad. Manipulating an icon results in the processing circuit 1010 sending a system instruction to one or more systems of the vehicle. A system instruction may be used to control (e.g., start, stop, pause, increase, decrease) the operation of the system. An icon may be positioned at any place on a system card and presented on the corresponding location on the display 140. An icon may be positioned a single square (e.g., L11, L12, so forth) or span multiple squares (e.g., L11-L21, L11-L31, L11-L13, so forth). A user may manipulate an icon by touching the corresponding square or squares on the haptic pad 210.

In an example embodiment, when the user touches the haptic pad 210, the processing circuit 1010 is configured to receive the touch information from the haptic pad 210. The processing circuit is configured to correlate the description of the portion of the haptic pad 210 touched by the user to a corresponding portion of the display 140 and thereby to the corresponding portion of the system card presented on the display 140. If the corresponding portion (e.g., corresponding to the portion of the haptic pad 210 touched by the user), includes the icon, the processing circuit 1010 is further configured to provide a system instruction in accordance with the icon to the one or more systems for controlling the operation of the one or more systems. System cards, icons, and the activation of icons are discussed in further detail below.

Upon receiving the system instruction, the system (e.g., 412-432) to which the system instruction was sent takes the action specified in the system instruction. The types of system instructions that a particular system may receive are identified in Table 1 in the column titled “Instructions Received”. For example, a system card may include an icon that enables the user to adjust the fan speed 610 of the environmental system 420. When the user touches the portions of the haptic pad 210 that correspond to the location of the fan speed 610 icon on the display 140, the processing circuit 1010 sends a system instruction to the environmental system 420 to set or adjust the fan speed. So, even though the icon is presented on the display 140 and not on the haptic pad 210, the user's touch on the haptic pad 210 activates the icon and controls the fan speed 610.

### Dual Display, Dual Haptic Pad User Interface

In another example embodiment, as best shown in FIG. 10, a user interface for presenting system information to a user and receiving system instructions from a user includes the display 140, the display 150, the haptic pad 210, the haptic pad 220, and the processing circuit 1010. The haptic pad 210 is configured to detect a first touch by a user. Responsive to the user's touch, the haptic pad 210 is further configured to provide a first touch information that includes a first description of a first portion of the haptic pad 210 touched by the user. The haptic pad 220 is configured to detect a second touch by the user. Responsive to the user's touch, the haptic pad 220 is further configured to provide a second touch information that includes a second description of a second portion of the haptic pad 220 touched by the user.

The processing circuit 1010 is configured to receive the system information from one or more systems 412-432 of the vehicle 100 regarding an operation of the one or more systems 412-432. The processing circuit 1010 is configured to use the system information to form a plurality of system cards (e.g., 500-900, SC01-SC07) for presenting on the display 140 or the display 150. As with the above example embodiment, any system card of the plurality of system cards may include an icon for controlling the one or more systems.

The processing circuit 1010 is configured to provide a first system card of the plurality (e.g., 500-900, SC01-SC07) to the display 140 for presenting to the user. The first system card includes a first icon (e.g., 612, 622, 632, 640, 650, 712, 722, 732, 812, 822, 832, 842, 852, 862, 912, 914, 952, 920, 930-938) for controlling the one or more systems. The processing circuit 1010 is configured to provide a second system card of the plurality (e.g., 500-900, SC01-SC07) to the second display 150 for presenting to the user. The second system card includes a second icon for controlling the one or more systems.

When the user touches the haptic pad 210, the processing circuit 1010 is configured to receive the first touch information from the haptic pad 210. When the user touches the haptic pad 210, the processing circuit 1010 is configured to receive the second touch information from the haptic pad 220.

The processing circuit 1010 is configured to correlate the first description of the first portion of the haptic pad 210 touched by the user to a first corresponding portion of the display 140 and thereby to the first corresponding portion of the first system card (e.g., 500-900, SC01-SC07) presented on the display 140. If the first corresponding portion the first system card includes the first icon (e.g., 612, 622, 632, 640, 650, 712, 722, 732, 812, 822, 832, 842, 852, 862, 912, 914, 952, 920, 930-938), the processing circuit 1010 is further configured to provide a first system instruction in accordance with the first icon to the one or more systems for controlling the operation of the one or more systems.

The processing circuit 1010 is configured to correlate the second description of the second portion of the haptic pad 220 touched by the user to a second corresponding portion of the display 150 and thereby to the second corresponding portion of the second system card (e.g., 500-900, SC01-SC07) presented on the display 150. If the second corresponding portion the second system card includes the second icon (e.g., 612, 622, 632, 640, 650, 712, 722, 732, 812, 822, 832, 842, 852, 862, 912, 914, 952, 920, 930-938), the processing circuit 1010 is further configured to provide a second system instruction in accordance with the second icon to the one or more systems for controlling the operation of the one or more systems.

Upon receiving the first system instruction and/or the second system instruction, the systems (e.g., 412-432) to which the first and second system instructions were sent takes the action specified in the instructions as discussed herein.

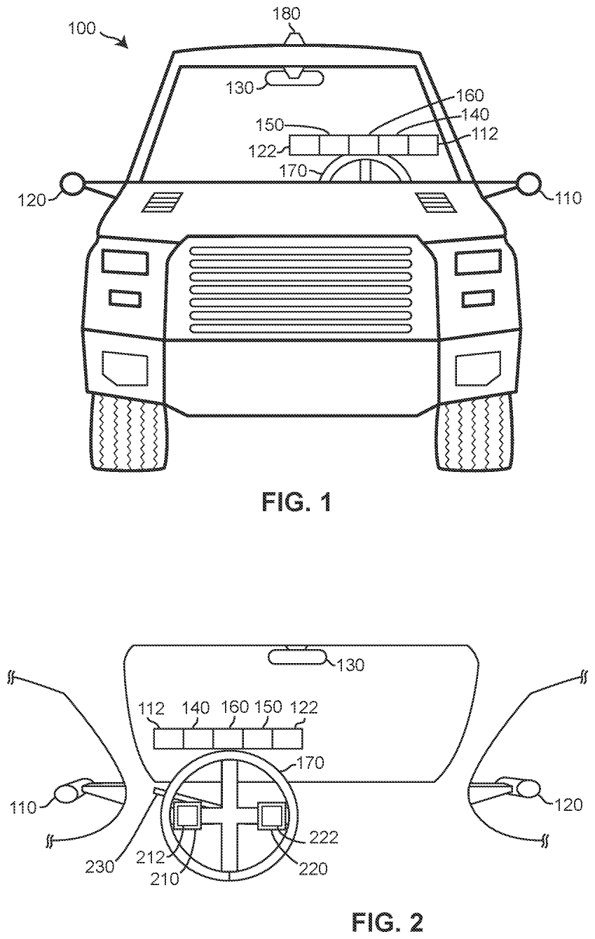

An example embodiment as seen from the perspective of the user is best seen in FIGS. 1-3. The displays 140, 150 and 160 are positioned (e.g., integrated into) on or near the dashboard of vehicle 100. The displays 140, 150 and 160 are positioned to be visible to the user of the vehicle 100. The haptic pads 210 and 220 are positioned on the steering wheel 170. The displays 140 and 150 present information from the systems 412-432 in the form of system cards (e.g., 500-900, SC01-SC07). The display 160 may be used to display information that is generally needed by a user to operate the vehicle. Although the information displayed on the display 160 may be programmable by the user, the information presented generally is not changed during operation of the vehicle 100. The display 160 may display information such as the time of day 300, the outside temperature 312, the bright beam status 314, the mode 318, the odometer 316, and the speedometer 320.

The haptic pads 210 and 220 are positioned on the steering wheel 170. The surfaces of the haptic pads 210 and 220 are positioned to be readily accessible to the touch of the user. The haptic pads 210 and 220 may be positioned to be easily accessible by the user's thumbs without the user removing their hands from the steering wheel 170. The haptic pads 210 and 220 may be sized for ease-of-use using the user's thumbs.

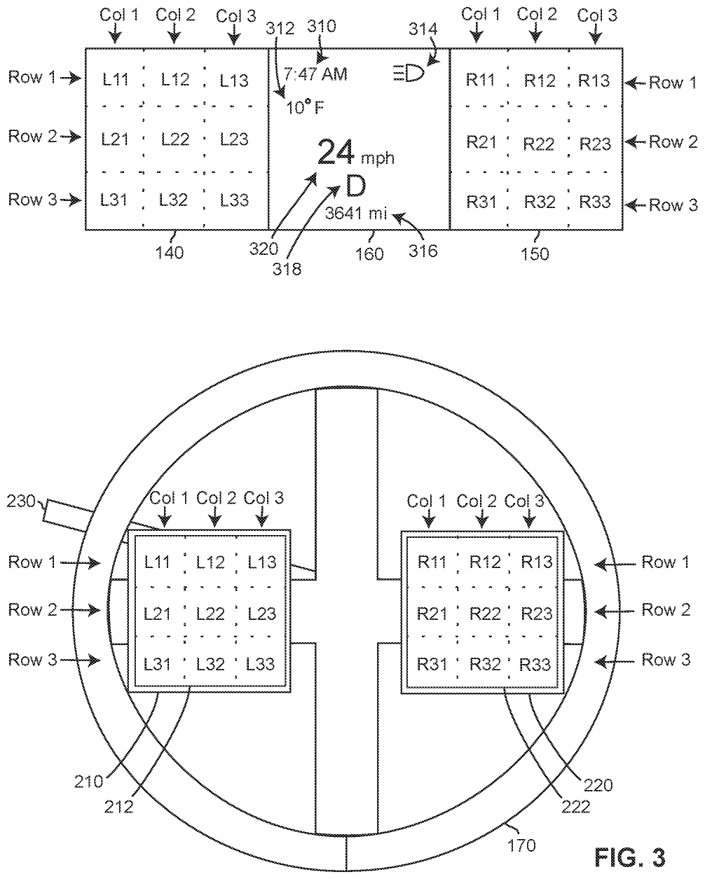

As discussed above, the haptic pad 210 and 220 may be divided into portions (e.g., squares) that correspond to the portions of the displays 140 and 150 respectively. In the embodiments of FIGS. 3 and 10, the haptic pads 210 and 220 are divided into nine portions organized as three rows and three columns. The displays 140 and 150 are also divided into nine portions of three rows and three columns respectively. As discussed above, the processing circuit 1010 correlates the portions of the haptic pad 210 the portions of the display 140, such that L11 (e.g., Left 11) on the haptic pad 210 corresponds to L11 (e.g., Left 11) on the display 140, L12 corresponds to L12, and so forth. The processing circuit 1010 also correlate the portions of the haptic pad 220 the portions of the display 150, such that R11 (e.g., Right 11) on the haptic pad 220 corresponds to R11 (e.g., Right 11) on the display 150, R12 corresponds to R12, and so forth. Accordingly, when the user touches a portion on the haptic pad 210 or 220, the processing circuit 1010 correlates the touch to the corresponding portion of the display 140 and the display 150 respectively.

The haptic pad 210 need not have the same number of rows and columns as the haptic pad 220. In the embodiments shown in FIGS. 3 and 10, the number of rows and the number of columns for the haptic pad 210 and 220 are the same; however, one haptic pad (e.g., 210) and its corresponding display (e.g., 140) may have more or fewer rows and/or columns than the other haptic pad (e.g., 220) and corresponding display (e.g., 150).

The haptic pads 210 and 220 may include ridge 212 and ridge 222 respectively that enclose the respective areas of the haptic pads 210 and 220. The ridge 212 and the ridge 222 provide a tactile delineation of inside and outside of the active area of the haptic pads 210 and 220. The haptic pads 210 and 220 may further include ridges between the portions (e.g., squares) to provide tactile information as to the location of the users touch on the haptic pads 210 and 220. The ridge 212, the ridge 222, and any ridges between portions of the haptic pads 210 and 220 enables a user to access the various portions of the haptic pad by feel and not visually. A haptic pad capable of detecting the force of a touch may detect, but not report a touch that is less than a threshold to allow a user to feel across the haptic pad to find a particular location. Once the user has identified the desired location on the haptic pad, the user may provide more touch force (e.g., heavier touch, more pressing force) that is detected and reported by the haptic pad as a detected touch and/or a detected movement (e.g., swipe).

### System Cards for System Information and Instruction Icons

As discussed above, each system (e.g., 412-432) of the vehicle provides information (e.g., system information) about its operation. Each system is configured to provide some or all of the information identified in the column labeled “information provided” in Table 1 above. The system information identified in Table 1 is not limiting as more or less information may be provided by a system. The systems are configured to provide their respective system information to the processing circuit 1010.

In an example embodiment, the power system 412 of an ICE vehicle provides information such as the oil level of the engine, the oil pressure of the engine, the temperature of the engine, and so forth. The power system 414 of an electric vehicle provides information such as the temperature of a motor, the RPMs of a motor, the hours of operation of a motor, and so forth. The information from a system is formatted into what is referred to as a system card. The format and the location of system information on a system card is configured to be presented on a display (e.g., 140, 150). The processing circuit 1010 is configured to format the system information from one or more systems into one or more system cards.

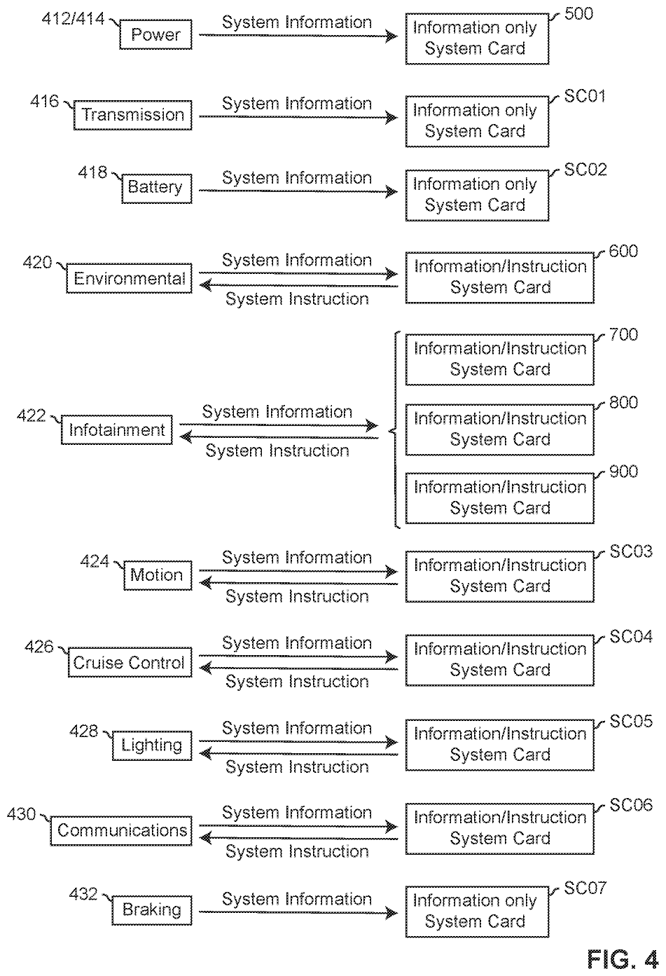

All systems provide system information regarding their operation; however, not all systems receive instructions (e.g., system instructions) via the user interface to control the operation of the system. System cards for systems that do not receive instructions via the user interface, as shown in FIG. 4, include the power system 412/414, the transmission system 416, the battery system 418, and the braking system 432. A system card for a system that does not receive system instructions via the user interface do not include icons. As discussed above, icons are part of a system card and are presented on the display (e.g., 140, 150, 160) to enable the user to manipulate the icon to control the system. A system that is not controlled via the user interface need not present icons on its system cards.

As shown in FIG. 4, the power systems 412/414, the transmission system 416, the battery system 418 and the braking system 432 provide system information for presentation on system cards, but do not receive system instructions via the user interface. For example, the power systems 412 and 414 receive instructions from the user to control the RPMs of their respective engines via a gas pedal. The transmission system 416 receives instructions from the user via a mode selector for an automatic transmission or via a stick for a manual transmission. The battery system 418 receives no instructions from a user. The braking system 432 receives instructions from the user to engage or disengage the brakes via a brake pedal. Because these systems do not receive system instructions from the user interface, the system cards for these systems do not include icons. As discussed above, a display (e.g., 140, 150) present icons to enable the user to manipulate the icons using a haptic pad (e.g., 210, 220). Manipulating the icon causes a system instruction to be sent to the system associated with the system card and the icon to control the system. In an example implementation, manipulating an icon provides information to the processing circuit 1010, which in turn sends a system instruction to the appropriate system in accordance with the icon.

A system is configured to provide information to the processing circuit 1010. The processing circuit 1010 is configured to format information into one or more system cards. Formatting includes identifying (e.g., tagging) information so that it is presented on a display (e.g., 140, 150, 160) at a particular location. The processing circuit 1010 may store the system card templates 1022 in the memory 1020. A system card template 1022 may be used to format information for presentation. A template may identify where particular information from a system should be positioned on a system card and therefore on a display. A template may combine information from different systems for presentation, such as the information presented on the display 160 as seen in FIG. 6.

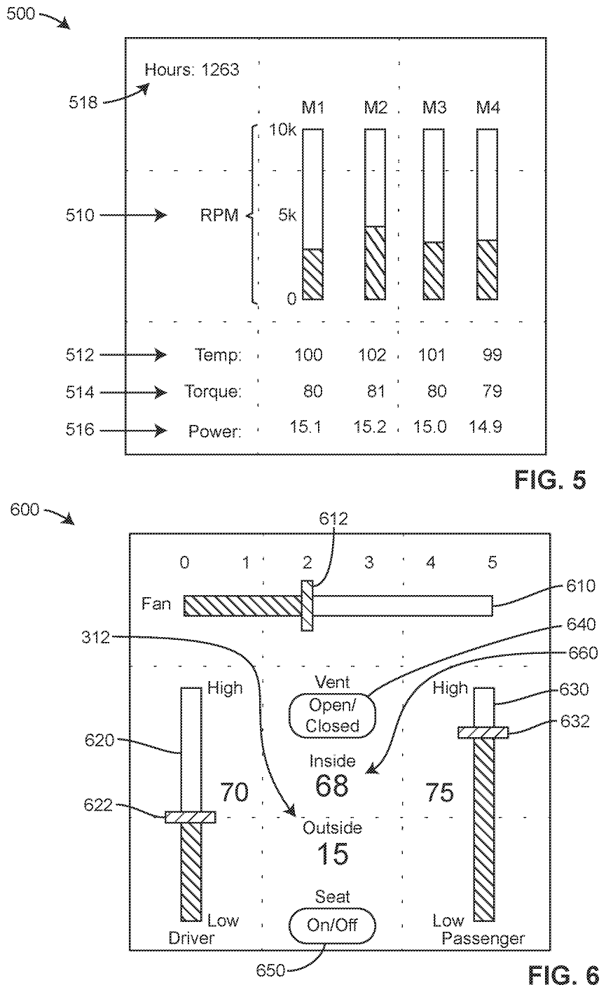

In an example embodiment, as best seen in FIG. 4, information from the power system 412/414, the transmission system 416, the battery system 418, and the braking system 432 is formatted by the processing circuit 1010 into the information only system cards 500 (see FIG. 5), SC01, SC02, and SC07 respectively. The identifiers SC01-SC07 identify system cards for which an example embodiment of their format is not provided herein. The system cards 500, SC01, SC02, and SC07 do not include icons because their operation cannot be controlled by a user via the user interface.

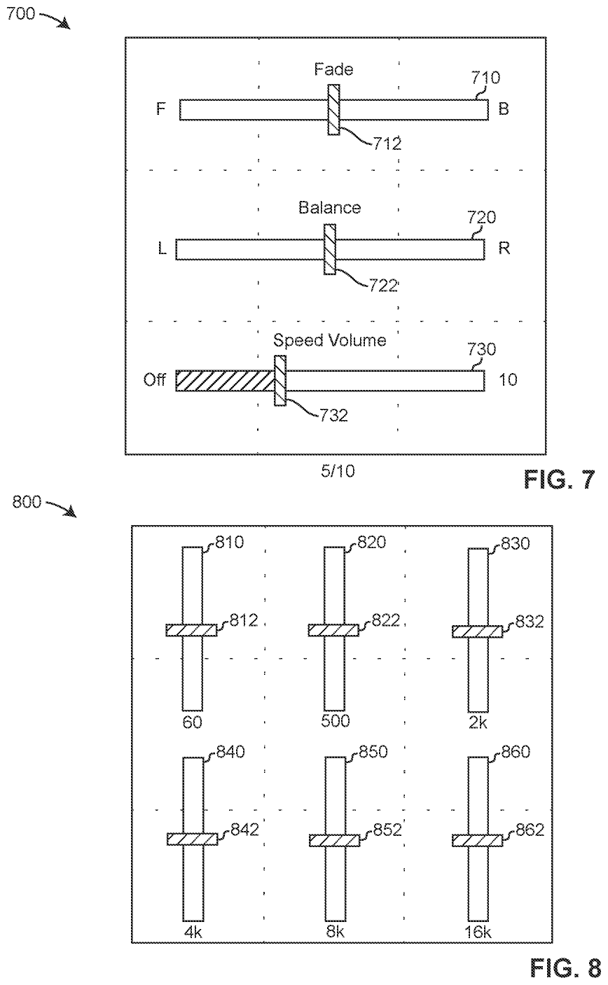

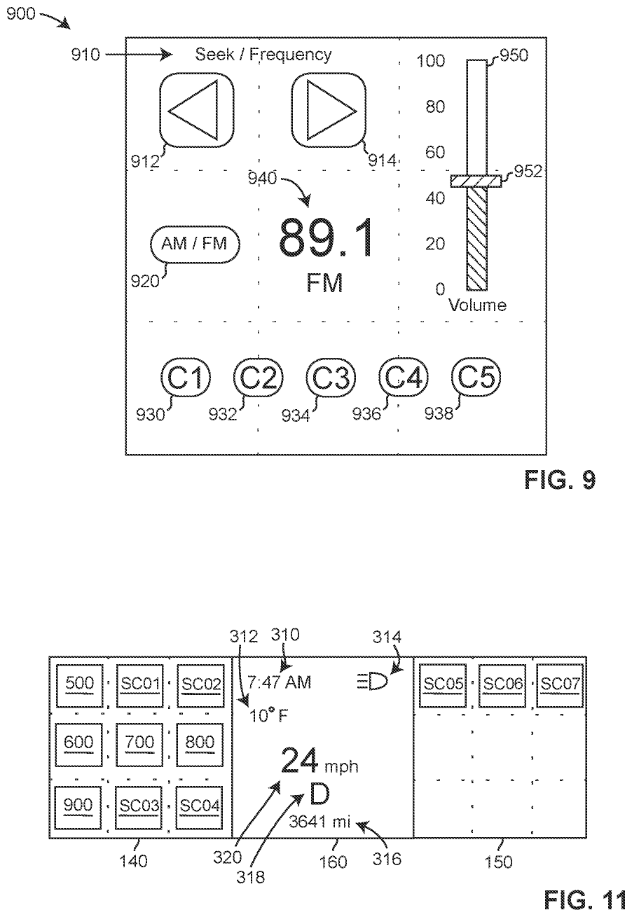

The environmental system 420, the infotainment system 422, the motion system 424, the cruise control system 426, and the lighting system 428 both provide system information to and receive system instructions from the user interface. The system information from the environmental system 420, the motion system 424, the cruise control system 426, and the lighting system 428 is formatted into the system cards 600 (see FIG. 6), SC03, SC04, SC05 and SC06 respectively. The information from the infotainment system 422 is formatted into the system cards 700, 800, and 900 (see FIGS. 7-9).

The system cards 600, 700, 800, 900, SC03, SC04, SC05 and SC06 also include icons that may be manipulated by a user to provide system instructions to the environmental system 420, infotainment system 422, the infotainment system 422, the motion system 424, the cruise control system 426, and the lighting system 428. An icon may display information regarding the state of an operation of a system, but it may also be manipulated by user using a haptic pad (e.g., 210, 220) to send a system instruction to one or more of the systems.

### Example Embodiment of System Card for Power System

For example, the system card 500 is an information only system card and does not include any icons. In an example implementation, the processing circuit 1010 formats the system information from the power system 414 to present the information as shown in FIG. 5. In this example implementation, the system card 500 is for the power system 414 for an electric vehicle, which includes one electric motor for each tire. The system card 500 includes four columns of information, one for each electric motor. The columns are labeled M1 for the first motor, M2 for the second motor, and so forth. The RPMs 510 of each motor are presented as bar graphs. The slip of any one motor is indicated by the color of the RPM bar graph for that motor. For example, in an example embodiment, the RPMs are presented in a blue color. If a motor begins to slip, its RPM bar graph is presented in a red color. The system card 500 further presents the temperature 512 in Fahrenheit, the torque 514 as a percentage of the maximum torque, and the power 516 consumed in kilowatts of each motor. The number of hours 518 that the motors have operated is also presented.

Since there are no icons on the system card 500, the position of the information presented in the system card 500 does not need to correspond to a location (e.g., L11, L12, L13, L21, so forth) on the display (e.g., 140, 150) or on the haptic pad (e.g., 210, 220).

Because the environmental system 420, the infotainment system 422, the motion system 424, the cruise control system 426, and the lighting system 428 receive system instructions via the user interface, the system cards for these systems are formatted to include both information and icons that may be manipulated to create system instructions. In an example embodiment, the system card 600 presents both system information regarding the operation of the environmental system 420 and includes icons for generating system instructions for controlling the operation of the environmental system 420.

### Example Embodiment of System Card for Environmental System

The system card 600 presents the inside temperature 660 and the outside temperature 312, which do not function as icons. System card presents the fan speed 610, the driver-side desired temperature 620, the passenger-side desired temperature 630, the vent status 640, and the seat heating status 650. The fan speed 610, the driver-side desired temperature 620, the passenger-side desired temperature 630, the vent status 640, and the seat heating status 650 also function as icons that allow a user to manipulate the icons to increase or decrease the fan speed, increase or decrease the drive-side desired temperature, increase or decrease the passenger-side desired temperature, open or close the vent, or turn the seat heater on or off

Fan speed 610 includes the slider 612. A user may manipulate the slider 612, via a haptic pad (e.g., 210, 220) to increase or decrease the current fan speed. For this example embodiment, assume that the system card 600 is being presented on the display 140. The fan speed 610 icon is formatted on the system card 600 to be presented on row 1 across columns 1-3, or in another words the fan speed 610 icon is presented across positions L11, L12, and L13. A user may manipulate the fan speed 610 icon to increase the speed of the fan by touching and swiping haptic pad 210 in a rightward direction across the corresponding row 1 of the haptic pad 210. The haptic pad 210 reports touch information to the processing circuit 1010 that describes a swipe from L11 to L13. The processing circuit 1010 correlates the touch on the haptic pad 210 from L11 to L13 as activating the fan speed 610 icon to move the slider 612 in a rightward direction. Responsive to the swipe touch on the haptic pad 210, the processing circuit 1010 sends a system instruction to the environmental system 420 to increase the fan speed. Further, the processing circuit 1010 updates the fan speed 610 as presented to move the slider 612 rightward to represent operation of the fan at a higher speed. Accordingly, an icon both presents system information, in this case current fan speed, and operates as an icon to enable the user to adjust the fan speed via a touch on the haptic pad 210.

The driver-side desired temperature 620 and passenger-side desired temperature 630 also both operate as icons. The driver-side desired temperature 620 icon is activated to increase the desired temperature by a swipe touch by the user on haptic pad 210 that begins at position L31, continues from position L31 to position L21 and ends at position L21. The driver-side desired temperature 620 icon is activated to decrease the desired temperature by a swipe touch by the user on haptic pad 210 that swipes from position L21 to position L31. After a user has touch swiped to activate the driver-side desired temperature 620 icon, the processing circuit 1010 sends an appropriate system instruction to the environmental system 420 to increase or decrease the temperature on the passenger side. The processing circuit 1010 further updates the driver-side desired temperature 620 by moving the slider 622 up or down in accordance with the touch swipe provided by the user. The processing circuit 1010 further updates the digital presentation of the temperature selected for the driver-side. The locations L33 and L23 may be swiped to activate the passenger-side desired temperature 630 icon, responsive to which the processing circuit 1010 sends a system instruction to the environmental system 420 and updates the passenger-side desired temperature 630 information (e.g., side 632 position, digital presentation of selected temperature).

The vent status 640 acts as an icon responsive to a touch on the location L22. Note that the vent status 640 icon is the only icon at the location L22 on the haptic pad 210. To toggle the vent status 640, the user performs a single touch (e.g., touch and lift) on the location L22 of the haptic pad 210. The processing circuit 1010 detects the touch, sends a system instruction to the environmental system 420 to toggle the vent operation (e.g., off to on, on to off), then updates the vent status 640 information to display the vents current operating status. The vent status 640 may display the word open or closed to identify the status of the vent or it may change colors to present a red color if closed and a green color if open. The seat heating status 650 further operates as an icon. Note that the seat heating status 650 is the only icon at the location L32. To toggle the seat heating status 650, the user performs a single touch at the location L32 on the haptic pad 210. The processing circuit 1010 detects the touch (e.g., receives attached information from the haptic pad 210), send a system instruction to the environmental system 420 to toggle the operation of the seat heater, then updates the seat heating status 652 two present the current operating status of seat heater.

Example Embodiment of System Cards for infotainment System

The infotainment system 422 performs so many functions with so many aspects that can be controlled by a user that the infotainment system 422 has three system cards. Most of the information presented in the system cards 700, 800 and 900, for the infotainment system, also function as icons. For example, the system card 700 presents the status of the fade 710, the balance 720, and the speed volume 730 of the infotainment system 422. The fade 710, the balance 720 and the speed volume 730 provide information as to the current status of the fade, the balance and the speed volume in addition to functioning as icons to enable the user to adjust the fade, the balance, and the speed volume.

In this example embodiment, assume that the system card 700 is presented on the display 150. The fade 710 is located on row 1 across columns 1-3 (e.g., R11 to R13). The icon is activated to change the status of the fade 710 when the user swipes the haptic pad 220 from the location R11 across to the location R13 or vice a versa. The processing circuit 1010 detects the swipe, sends a system instruction to the infotainment system to change the fade, and updates the position of the slider 712 to indicate the current status of the fade 710. The balance 720 icon is activated by a swipe by the user on the haptic pad 220 from the location R21 to the location R23 or vice a versa. The speed volume 730 icon is activated by a swipe by the user on the haptic pad 220 from the location R31 to the location R33 or vice a versa. Activation of the balance 720 icon or the speed volume 730 icon causes the processing circuit 1010 to send an appropriate system instruction to the infotainment system 422 to change the balance or the speed volume, and to update the current status of the sliders 722 and 732 to show the current status of the balance and the speed volume.

In several instances, an icon is been described as spanning three columns or three rows. In each instance, the swipe touch described activate the icon has been described as a touch that moves across all three columns or all three rows. In another example embodiment, an icon that spans three columns may be activated by a swipe across 1.5 to 3 columns. In other words, for an icon that spans three columns, the user may swipe touch across only a fraction of the icon to activate the icon. The user must swipe touch across enough of the icon, enough of the columns, for the touch information to represent a swipe in a direction of the swipe. When the processing circuit 1010 receives the touch information, it can recognize that the user swiped one direction or the other across an icon, so the processing circuit 1010 may activate the icon as indicated by the swipe. The same concept applies for icons that span three rows. Indeed, for icons that span two columns or two rows, a swipe touch across 1.5 to 2 columns or rows respectively is sufficient for the processing circuit 1010 to recognize a swipe into activate the icon.

The equalizer for the infotainment system 422 is presented in system card 800. The various ranges of frequency that may be equalized are presented as the bar graphs 810, 820, 830, 840, 850, and 860 with the sliders 812, 822, 832, 842, 852, and 862 respectively. The bar graphs are presented as covering two locations (e.g., rows) on the display. Assume in this example embodiment that the system card 800 is presented on the display 150. The bar graph 810 spans the locations R21 and R11. A user swipe on the haptic pad 220 starting at the location R21 and ending at the location R11 or vice a versa starting at the location R11 and ending at the location R21 activates the slider 812 on the bar graph 810. The processing circuit 1010 detects the direction of the swipe (e.g., R21 to R11, R11 to R21), sends a system instruction to the infotainment system to change the equalization for the frequency band of the bar graph 810, and updates the position of the slider 812 on the bar graph 810 to represent the current selected setting for the bar graph 810. Activation of the other icons works similarly. Activation of the bar graph 820 icon, the bar graph 830 icon, the bar graph 840 icon, the bar graph 850 icon, and the bar graph 860 icon are activated by swipes between the locations R22-R12, R23-R13, R21-R31, R22-R23 and R23-R33 respectively by the user on the haptic pad 220. For each swipe, the processing circuit sends an appropriate system instruction to infotainment system 422 and updates the slider (e.g., 822, 832, 842, 852, and 862) on the bar graph to represent the current status.

The system card 900 presents information regarding the operation of the radio of the infotainment system 422 and icons for the control of the radio. The seek 912, the seek 914, the band 920, the saved channels 930-938, and the volume 950 provide information as to the status of the function and also operate as icons. The channel 940 presents the current radio channel and the band (e.g., AM, FM) and does not function as an icon. Assume for this example, that the system card 900 is presented on the display 140. The seek 912 and the seek 914 are activated to toggle their status by the user doing a single touch on the location L11 and the location L12 respectively of the haptic pad 210. The band 920 is activated to toggle between the AM and the FM bands by the user doing a single touch on the location L21 on the haptic pad 210. The volume 950 is activated to set the volume by the user doing a swipe touch from the location L13 to L23 or visa versa. The saved channel 930, 934 and 938 icons are activated by the user performing a single touch on the location L31, the location L32, and the location L33 respectively on the haptic pad 210. The saved channel 932 and 936 icons are activated by the user performing a single touch at the locations L31 and L32, and the locations L32 and L33 at the same time. Touching at the boundary between the locations L31 and L32 or the locations L32 and L33 may be construed as touching both the locations L31 and L32 or L32 and L33 at the same time.

Each time the user touches the haptic pad 210, the haptic pad 210 sends the touch information to the processing circuit 1010 that includes the location of the touch. The processing circuit 1010 correlates the location of the touch and the type of touch (e.g., single, swipe) to the location on the display 140 and the icons presented at the locations on the display 140. The processing circuit 1010 sends an appropriate system instruction to the infotainment system 422 and updates the information on the display 140 to show the current status of the icon.

Selecting System Cards for Display

In the example embodiments discussed above, the user interface includes one or two displays. While the user interface may include any number of displays and/or any number of haptic pads, it is likely that the number of system cards needed to display the system information and to present icons for controlling the systems will exceed the number of displays. Accordingly, there needs to be some way for a user to select which system cards are presented on the displays.

In the example embodiment that has the displays 140 and 150, best shown in FIGS. 3 and 10, a user may select any two of the plurality of system cards for presentation on the displays 140 and 150. In a first example embodiment of a system card selection system, the system cards are presented as thumbnail images on the display 140 and the display 150 as best shown in FIG. 11. One thumbnail is presented at each location (e.g., L11, L22, so forth, R11, R12, so forth) of the displays 140 and 150. The user may select the thumbnail of the system card to be presented on the displays 140 and 150 respectively. Any gesture or combination of gestures may be used to select a thumbnail and to identify the display on which the system card associated with thumbnail is to be presented. In an example embodiment, the user performs a single tap on the thumbnail of the system card to be presented on the display 140 and a double tap on the thumbnail of the system card to be presented on the display 150.

In an example embodiment, referring to FIG. 11, a user may select the system card 700 for presentation on the display 140 by performing a single tap touch on portion L22 of the haptic pad 210. The position L22 is the position on the display 140 where the thumbnail for the system card 700 is displayed. The user may select the system card 500 for presentation on the display 150 by performing a double tap touch on portion L11 of the haptic pad 210. The position L11 is the position on the display 140 where the thumbnail for the system card 500 is displayed. After the thumbnail so been selected, the processing circuit 1010 presents the associated system cards on the selected displays. Any gestures other than a single tap touch and a double tap touch may be used to select a thumbnail. For example, a touch and left a swipe and a touch and right swipe may be used to select the thumbnail for the system cards to be splayed on the display 140 and the display 150 respectively.

Any gesture or combination of gestures may be used instruct the processing circuit 1010 to present the thumbnails of the system cards on the displays 140 and 150 for selection. In an example embodiment, a V-shaped gesture performed on either haptic pad 210 or the haptic pad 220 instructs the processing circuit 1010 to present the thumbnails on the displays 140 and 150. The V-shaped gesture may be performed horizontally or vertically. A V-shaped gesture is formed by touching the haptic pad, retaining contact with haptic pad while moving in a first direction, changing directions and retaining contact with haptic pad while moving in a second direction nearly opposite to the first direction, then ceasing contact.

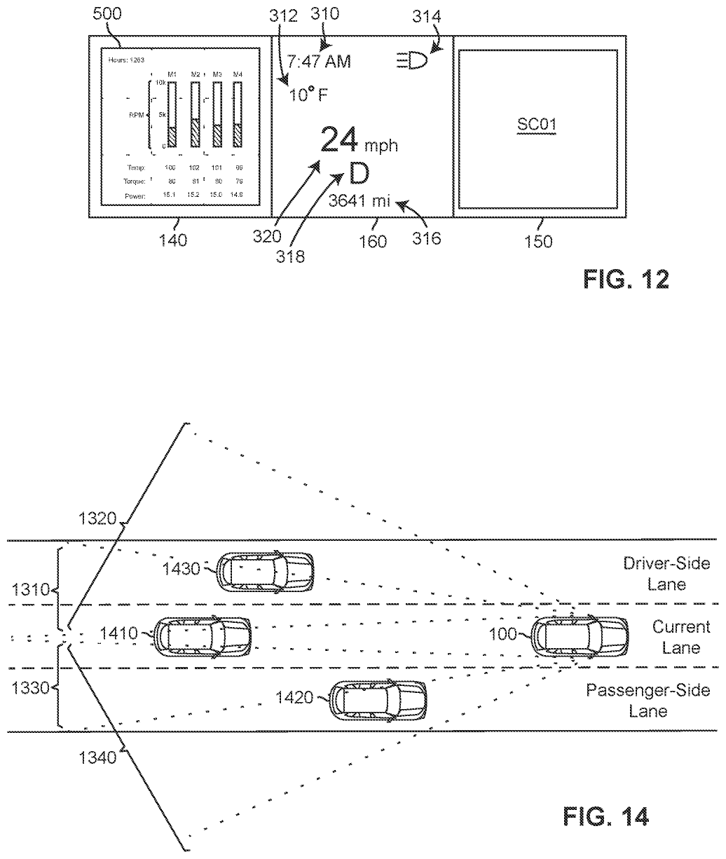

In an example embodiment, referring to FIG. 12, the user may instructor the processing circuit 1010 to present system cards on one or both of the displays 140 and 150. The user may then scroll through the system cards to select the system card to be presented on each display. In an example embodiment, the user uses the V-shaped gesture to instruct the processing circuit 1010 to present the system cards on the displays 140 and 150. The user swipes left or right on the haptic pad 210 to scroll through the system cards on the display 140. When the system card that the user wants to have presented on the display 140 appears, the user performs a gesture on the haptic pad 210 (e.g., single tap touch, double tap touch) to select that system card for presentation on the display 140. The user swipes left or right on the haptic pad 220 to scroll through the system cards on the display 150. When the system card the user wants to have presented on the display 150 appears, the user performs a gesture on the haptic pad 220 to select that system card for presentation on the display 150.

### Interpretation of Gestures

As discussed above, any gesture may be used to perform any function. In an example embodiment, the processing circuit 1010 receives the touch information from haptic pad 210 and/or the haptic pad 220 respectively responsive to the user touching the haptic pads. The touch information identifies where the touch starts, the direction of continued touching, and where the touch ends. The processing circuit 1010 may use information from a gesture library 1024 stored in the memory 1020 to interpret the touch information to determine the type of gesture performed and the meaning of the gesture. For example, as discussed above, a V-shaped gesture may be construed to mean that the processing circuit 1010 should display the system cards for selection. The gesture library 1024 may store a plurality of gestures and associated functions that should be performed by the processing circuit 1010.

Single Camera Rearview System Embodiment with Collision Warning

Conventional vehicles may include mirrors to provide information of what is positioned or occurring to the side or behind the vehicle. The mirrors provide a rearward view from the perspective of the user of the vehicle. In an example embodiment, a vehicle includes a rearview system that provides the operator information of what is positioned or occurring to decide and/or behind the vehicle, but also is configured to detect potential collisions.

In an example embodiment, a rearview system is for a first vehicle 100. The rearview system is configured to detect a potential collision between the first vehicle 100 and a second vehicle. The rearview system comprises a detector, a camera, a display, and a processing circuit.

The detector is configured to be mounted on the first vehicle 100. In an example embodiment, a detector 1380 is mounted on a rear of the first vehicle 100. The detector 1380 is configured to detect an information regarding the second vehicle (e.g., 1410, 1420, 1430, 1510, 1520, 1530) positioned to decide or rearward of the first vehicle 100. The detector 1380 is configured to detect the information regarding the second vehicle, whether the second vehicle is positioned directly behind the vehicle 100 (e.g., same lane, current lane) or to the left (e.g., left lane, driver-side lane) or to the right (e.g., right lane, passenger-side lane) of the first vehicle 100. Information captured by the detector 1380 may include the presence of the second vehicle, the speed of the second vehicle, the position of the second vehicle in the field-of-view of the detector 1380, the position of the second vehicle relative to a lane (e.g., current, driver-side, passenger-side), an acceleration of the second vehicle or a deceleration of the second vehicle. The processing circuit 1010 is configured to receive the information from the detector 1380. The processing circuit 1010 is configured to determine the speed of the second vehicle relative to the speed of the first vehicle 100, the position of the second vehicle relative to the position of the first vehicle 100, the lane of the second vehicle relative to the lane of the first vehicle 100, the acceleration of the second vehicle relative to the acceleration of the first vehicle 100, and the deceleration of the second vehicle relative to the first vehicle 100.

The detector 1380 may include any type of sensor for detecting or measuring any type of physical property, such as speed sensors, distance, acceleration, and direction of movement. Detector 1380 may include radar, LIDAR, thermometers, speedometers, accelerometers, velocimeters, rangefinders, position sensors, microphones, light sensors, airflow sensors, and pressure sensors.

The first vehicle 100 may include sensors that detect the speed, the position, the position respective to a lane, the acceleration, and/or the deceleration of the first vehicle 100. The sensors are adapted to provide their data to the processing circuit 1010.

In an example embodiment, a camera 180 is configured to be mounted on the first vehicle 100 and oriented rearward to capture a video data rearward of the first vehicle 100. The video data includes an image of the second vehicle (e.g., 1410, 1420, 1430, 1510, 1520, 1530). The camera 180 captures an image of the second vehicle relative to the lanes (e.g., current, driver-side, passenger-side). An image of the second vehicle may appear in subsequent frames of the video data, so the image of the second vehicle in the frames of video data provided by the camera 180 may change over time. For example, the size of the second vehicle may increase or decrease as a second vehicle approaches or recedes from the first vehicle 100. The rate of increase or decrease in the size of the second vehicle in subsequent frames may change as the second vehicle accelerates or decelerates respectively.

In an example embodiment, the processing circuit 1010 is configured to use the video data from the camera 180 to perform the functions of the detector 1380. Processing circuit 1010 may perform analysis on the video data provided by the camera 180 to determine all of the information described above as being detected by the detector 1380. In an example embodiment, the processing circuit 1010 uses the video data captured by the camera 180 to perform all of the functions of the detector 1380.

The display is configured to be mounted in the first vehicle. In an example embodiment, a display 122 is mounted on or near a dashboard of the vehicle 100. The display 122 is positioned for viewing by a user of the vehicle 100. The display 122 is configured to receive and present the video data. The video data may be provided to the display 122 by the camera 180. Video data may be provided by the camera 180 to the processing circuit 1010, which in turn provides the video data to the display 122. The image of the second vehicle (e.g., 1410, 1420, 1430, 1510, 1520, 1530) is visible in the video data presented by the display 122. The video data presented on the display 122 enables the user the vehicle to be aware of the presence of the second vehicle rearward of the first vehicle 100.

In an example embodiment, the processing circuit 1010 is configured to receive the information regarding the second vehicle (e.g., 1410, 1420, 1430, 1510, 1520, 1530) from the detector 1380. In another example embodiment, the processing circuit 1010 is configured to use the video data from the camera 180 to determine the information regarding second vehicle. The processing circuit 1010 is configured to determine the speed of the second vehicle relative to the speed of the first vehicle 100. The processing circuit 1010 is configured to determine the position of the second vehicle relative to the position of the first vehicle 100. The processing circuit 1010 is configured to determine the lane in which the second vehicle travels relative to the lane in which the first vehicle 100 travels. The processing circuit 1010 is configured to determine the acceleration of the second vehicle relative to the speed and/or acceleration of the first vehicle 100. The processing circuit 1010 is configured to detect a potential collision between the second vehicle and the first vehicle 100. The processing circuit 1010 may detect a potential collision by estimating a future (e.g., projected, predicted) position of the second vehicle based on the current position, direction of travel, course of travel, speed of the second vehicle relative to the first vehicle 100, and/or acceleration of the second vehicle relative to the first vehicle 100. In the event that the processing circuit 1010 determines that the position of the second vehicle will overlap or coincide with position of the first vehicle 100, the processing circuit 1010 has detected a potential collision between the second vehicle and the first vehicle 100.

Responsive to detecting a potential collision between the second vehicle (e.g., 1410, 1420, 1430, 1510, 1520, 1530) and the first vehicle 100, the processing circuit 1010 is configured to present a warning on the display 122. In an example embodiment, the warning comprises illuminating a portion of the display with a color. In an example embodiment, the processing circuit 1010 illuminates a top portion of the display 122. In another example embodiment, the processing circuit 1010 illuminates a top edge of the display 122 to not interfere with the video data presented on the display 122. In another example embodiment, the processing circuit 1010 illuminates an outer portion around the display 122. In another example embodiment, the processing circuit 1010 illuminates an outer portion along a top of the display 122. In another example embodiment, the processing circuit 1010 illuminates an outer portion along a bottom of the display 122. In another example embodiment, as best seen in FIG. 16, the processing circuit illuminates a top portion of the display 122 and a portion of each side of the display 122. In an example embodiment, the color of the warning comprises the color red. In another example embodiment, the processing circuit 1010 causes a portion of the display 122 to flash the color (e.g., red).

The processing circuit 1010 may take into account anticipated movements of the first vehicle 100 when determining whether a potential collision may occur between the second vehicle (e.g., 1410, 1420, 1430, 1510, 1520, 1530) and the first vehicle 100. In an example embodiment, the processing circuit 1010 is further configured to: receive a signal from a turn indicator of the first vehicle 100 and to detect the potential collision between the second vehicle and the first vehicle 100 if the first vehicle moves from a current lane to a driver-side lane or a passenger-side lane as indicated by the signal from the turn indicator. The processing circuit 1010 is configured to present the warning on the display in accordance with whether the second vehicle is positioned in the driver-side lane or the passenger-side lane. If the second vehicle is positioned in the passenger-side lane, the processing circuit presents the warning on a passenger-side portion of the display and if the second vehicle is positioned in the driver-side lane, the processing circuit presents the warning on a driver-side portion of the display.

In an example embodiment, as best shown in FIG. 18, the processing circuit 1010 may present a warning in the portion 1830 of the display 122 in the event that a collision may occur with the vehicle 1430 positioned in the driver-side lane. The processing circuit 1010 may present a warning in the portion 1820 of the display 122 in the event that a collision may occur with the vehicle 1410 positioned in the current lane. The processing circuit 1010 may present a warning in the portion 1810 of the display 122 in the event that a collision may occur with the vehicle 1420 positioned in the passenger-side lane. The warning in the portion 1810, 1820, and 1830 may have the color 1812, 1822, and 1832 respectively. The warning may include a flashing light of a particular color. For example, the color red may indicate a potential collision. The color green may indicate that no collision is anticipated.

In another example embodiment, the first vehicle 100 includes one or more sensors for detecting a direction of movement of the first vehicle 100. The processing circuit 1010 may use the data from the one or more sensors to detect movement of the first vehicle 100. In accordance with the data, the processing circuit 1010 may detect a potential collision with a second vehicle if the first vehicle 100 continues to move in its current direction.

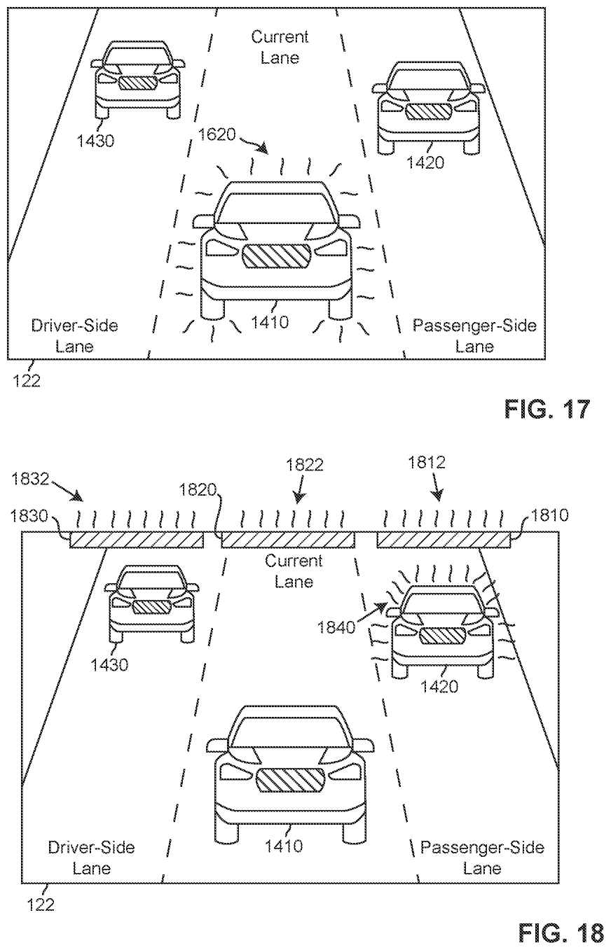

In another example embodiment, the processing circuit 1010 presents the warning on the display 122 by presenting the image of the second vehicle 1410 as having a color. For example, as best shown in FIG. 17, the image of the vehicle 1410 may be changed entirely, or just its outline 1620, to the color red. The processing circuit 1010 may change the color of the vehicle 1410 as presented on the display 122 using image processing. Changing the color of the image of the second vehicle (e.g., 1410, 1420, 1430, 1510, 1520, 1530) make it possible to identify which second vehicle of a plurality of second vehicles is likely to collide with the first vehicle 100. For example, as best seen in FIG. 14, assume that there are three vehicles traveling behind the vehicle 100, the vehicle 1430 in the driver-side lane, the vehicle 1410 directly behind in the current lane, and the vehicle 1430 in the passenger-side lane. In another example, best seen in FIG. 18, the color 1840 of the vehicle 1420 is change to indicate a possible collision.

For example, if the vehicle 1410 is accelerating toward the first vehicle 100 and is likely to collide with first vehicle 100 if it continues to accelerate, the processing circuit 1010 is configured to change the color of the vehicle 1410 as shown on the display 122 to be red to warn the operator of vehicle 100 of a possible collision. The colors of the vehicle 1420 and 1430 would not be altered. If the user of the first vehicle 100 has activated the turn indicator indicating a desire to move from the current lane into the driver-side lane, the processing circuit 1010 may determine the speed and acceleration of the vehicle 1430 to determine if a collision is possible between the first vehicle 100 and the vehicle 1430 if the lane change is made. If a collision is possible, the processing circuit 1010 is configured to change the color of the vehicle 1430 to red. If the user of the first vehicle 100 has activated the turn indicator indicating a desire to move from the current lane into the passenger-side lane, the processing circuit may determine the speed and acceleration of the vehicle 1420 to determine if a collision is possible between the first vehicle 100 and the vehicle 1420 if the lane change is made. If a collision is possible, the processing circuit 1010 is configured to change the color of the vehicle 1420 to red.

Dual Camera Rearview System Embodiment with Collision Warning

Conventional vehicles generally include a driver-side rearview mirror, a passenger-side rearview mirror and a center rearview mirror. The rearview mirrors of the vehicle may be replaced by one or more video cameras and one or more displays. In an example embodiment, the vehicle 100 includes a driver-side camera 110, a passenger-side camera 120, the display 112, and the display 122. The video data captured by the driver-side camera 110 is presented on the display 112. The video data captured by the passenger-side camera 120 is presented on the display 122.

In an example embodiment, the display 112 is positioned on a driver-side (e.g., left assuming a left-hand driving vehicle, right assuming a right-hand driving vehicle) of the steering wheel to approximate the position of a conventional driver-side rearview mirror. The display 122 is positioned on the passenger-side (e.g., right assuming a left-hand driving vehicle, left assuming a right-hand driving vehicle) of the steering wheel to approximate the position of a conventional passenger-side rearview mirror.

In the following example embodiments, the first vehicle 100 includes the dual camera rearview system embodiment that warns against possible collisions with a second vehicle (e.g., 1410, 1420, 1430, 1510, 1520, 1530). In an embodiment, the first vehicle 100 includes the driver-side camera 110, the passenger-side camera 120, the rearview camera 180, the display 112, the display 122, and a display 130. The driver-side camera 110, the passenger-side camera 120, the display 112, the display 122 are arranged as described above in the previous embodiment. The video data captured by the camera 180 is presented on the display 130.

In another example embodiment that includes a dual-mirror, dual display rearview system, as best shown in FIGS. 2 and 10, the system includes the detector 1380, the camera 110, the camera 120, the display 112, the display 122, and the processing circuit 1010.

As discussed above with respect to the example embodiment of the single camera rearward system, the detector 1380 is configured to be mounted on the first vehicle 100 and to detect an information regarding the second vehicle (e.g., 1410, 1420, 1430, 1510, 1520, 1530) positioned to the side or rearward of the first vehicle.

In this example embodiment, the detector 1380 is configured to detect the information regarding the second vehicle as discussed above with respect to the detector 1380.

The camera 110 is configured to be mounted on the driver-side of the first vehicle 100. The camera 110 is configured to be oriented rearward to capture a first video data along the driver-side and rearward of the first vehicle 100. The orientation identified as rearward means rearward with respect to the front of the first vehicle 100. The camera 120 is configured to be mounted on the passenger-side of the first vehicle 100. The camera 120 is configured to be oriented rearward to capture a first video data along the passenger-side and rearward of the first vehicle 100.

The display 112 is configured to be mounted toward the driver-side of a steering wheel of the first vehicle. In an example embodiment of the left-hand driving vehicle, best shown in FIGS. 2 and 10, the display 112 is mounted left of center of the steering wheel 170. The display 122 is configured to be mounted toward the passenger-side of the steering wheel of the first vehicle. In an example embodiment, best shown in FIGS. 2 and 10, the display 122 is mounted right of center of the steering wheel 170. The displays 112 and 122 may be mounted on the dash or integrated into the dash. In another example embodiment, the displays 112 and 122 may be heads-up displays. The displays 112 and 122 may be mounted alongside or near the displays 140, 150 and 160 that are used for the user interface. The display 112 is configured to receive and present the first video data that is captured by the camera 110. The display 122 is configured to receive and present the second video data that is captured by the camera 120.

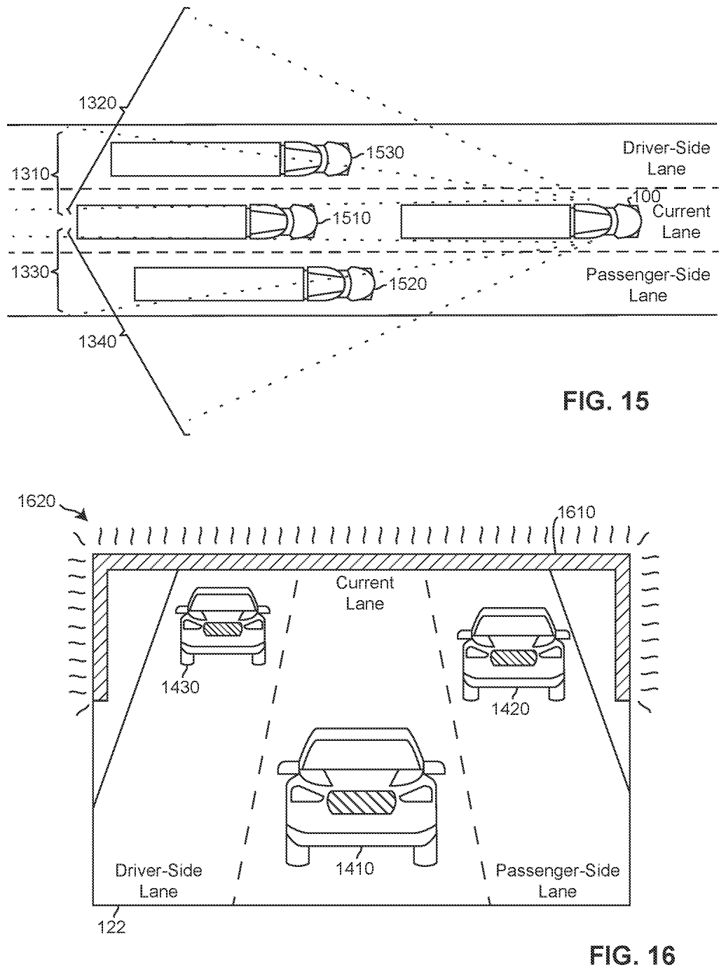

At least one of the first video data in the second video data includes an image of the second vehicle (e.g., 1410, 1420, 1430, 1510, 1520, 1530). In the event that more than one second vehicle is positioned to the side or rearward of the vehicle 100, the first video data and the second video data include an image, or a partial image, of some or all of the second vehicles positioned to the side or rearward of the vehicle 100. For example, in an example embodiment, referring to FIG. 14, the first vehicle 100 travels in a middle lane (e.g., current lane) of three lanes. The second vehicles 1410, 1420, and 1430 travel rearward of the first vehicle 100 in the driver-side, current, and passenger-side lanes respectively. The first and second video data captured by the cameras 110 and 120 respectively are presented on the displays 112 and 122 respectively. As best shown in FIG. 10, the display 112 includes an image of the second vehicle 1430 and a partial image of the vehicle 1410. The display 122 includes an image of the second vehicle 1420 and a partial image of the vehicle 1410. In an example embodiment, the video data presented on the display 112 and the display 122 are essentially equivalent to the images seen in a conventional driver-side rearview mirror and a passenger-side rearview mirror respectively. In another example embodiment, the video data presented on the display 112 and the display 122 provides more information (e.g., greater horizontal angle of capture, greater vertical angle of capture, more information behind the first vehicle 100). As illustrated in FIG. 15, the rearview system may function regardless of the length or size of the first vehicle 100 and the second vehicles 1510, 1520, and 1530.

As discussed above, in an example embodiment, the processing circuit 1010 is configured to receive the information regarding the second vehicle (e.g., 1410, 1420, 1430, 1510, 1520, 1530) from the detector 1380. As discussed above, the processing circuit 1010 may perform all or some of the functions of the detector 1380 by analyzing the first video data and the second video data. The processing circuit 1010 may be configured to analyze the first video data and the second video data to determine all or some of the information, discussed above, detected by the detector 1380. In another example embodiment, the processing circuit 1010 performs all of the functions of the detector 1380, so the detector 1380 is omitted from the embodiment. In this example embodiment, the processing circuit 1010 is configured to use the video data from the camera 110 and the camera 120 to determine the information regarding second vehicle.

In either of the above example embodiments, the processing circuit 1010 is configured to determine the speed of the second vehicle relative to the speed of the first vehicle 100. The processing circuit 1010 is configured to determine the position of the second vehicle relative to the position of the first vehicle 100. The processing circuit 1010 is configured to determine the lane, acceleration and the deceleration of the second vehicle relative to the first vehicle 100 as discussed above. Using the information regarding the first vehicle 100 and the second vehicle (e.g., 1410, 1420, 1430, 1510, 1520, 1530), the processing circuit 1010 is configured to detect a potential collision between the second vehicle and the first vehicle 100.

The processing circuit 1010 may detect a potential collision by estimating a future (e.g., projected, predicted) position of the second vehicle as discussed above. As discussed above, if the position of the second vehicle overlaps or will overlap or coincide with position of the first vehicle 100, the processing circuit 1010 has detected a potential collision.

Responsive to detecting a potential collision between the second vehicle (e.g., 1410, 1420, 1430, 1510, 1520, 1530) and the first vehicle 100, the processing circuit 1010 is configured to present a warning on at least one of the display 112 and the display 122. In an example embodiment, the processing circuit 1010 is configured to present the warning on the display 112 or the display 122 in accordance with whether the second vehicle is positioned in the driver-side lane or the passenger-side lane respectively. In an example embodiment, if the second vehicle is positioned in the driver-side lane, the processing circuit presents the warning on the display 112. If the second vehicle is positioned in the passenger-side lane, the processing circuit presents the warning on the display 122. In an example embodiment, if the second vehicle is positioned in the same lane as the first vehicle 100 (e.g., directly behind), the processing circuit may present the warning on the display 112, the display 122, or both.

As discussed above, in an example embodiment, the warning comprises illuminating a portion of the display with a color. The portions (e.g., top, side, bottom, top edge, side edges, bottom edge) of the display where the warning may be presented, described above with respect to the display 122, applies also to the display 112. As discussed above, the color the warning may be any color, including red. As further discussed above, the warning may include a flashing light.

As discussed above, the processing circuit 1010 may take into account the anticipated movements of the first vehicle 100 when determining whether a potential collision may occur with the second vehicle (e.g., 1410, 1420, 1430, 1510, 1520, 1530). As discussed above, a turn indicator may provide an indication of movement of the first vehicle 100 for predicting a possible collision. Sensors in the first vehicle 100 may detect movement of the first vehicle 100 predict a possible collision.

The processing circuit 1010 is configured to present the warning on the display in accordance with whether the second vehicle is positioned in the driver-side lane or the passenger-side lane. In an example embodiment, if the second vehicle is positioned in the passenger-side lane, the processing circuit 1010 is configured to present the warning on the display 122. If the second vehicle is positioned in the driver-side lane, the processing circuit presents the warning on the display 112. If the second vehicle is positioned in the current lane of the first vehicle 100, the processing circuit 1010 is configured to present the warning on either the display 112, the display 122, or both.

In an example embodiment, the processing circuit 1010 presents the warning on the display 112 and/or the display 122 by presenting the image of the second vehicle (e.g., 1410, 1420, 1430, 1510, 1520, 1530) as having a color. For example, as discussed above and best shown in FIG. 17, the image of the vehicle 1410 may be changed entirely, or just its outline, to the color red. As discussed above, the color of only the second vehicle that is likely to collide with the first vehicle 100 may be changed, while the color of all other vehicles remain the same.

The second vehicle (e.g., 1410, 1420, 1430, 1510, 1520, 1530) need not be close or next to the first vehicle 100 to predict that a collision is possible. For example, the first vehicle 100 may be traveling in the current lane but the user desires to change to the passenger-side lane. The detector 1380 may detect information or the processing circuit 1010 may use video data to determine information regarding the second vehicle in the passenger-side lane. Using the information regarding the second vehicle, the processing circuit 1010 may determine that if the first vehicle 100 were to change lanes to the passenger-side lane, the second vehicle would collide with first vehicle 100 in a matter of time (e.g., seconds) after the lane change. So, the processing circuit 1010 is configured to detect not only immediately or imminent collisions, such as if the second vehicle were directly across from the first vehicle 100 when the first vehicle 100 turns into its lane, but also collisions that may occur in the near future. The processing circuit 1010 is configured to extrapolate current trends in the operation of the first vehicle 100 and the second vehicles to identify the possibility of a collision. The processing circuit 1010 may provide a warning when, if the current conditions continue, a collision is possible. The processing circuit 1010 may identify the possible collision and warn the user of the first vehicle 100 via the display 112 and/or the display 122.

Rearward System with Different Fields of Capture

In an example embodiment, the rearview system captures video data having different fields-of-capture. A rearview system configured to capture video data having different fields-of-capture includes a camera 110, a camera 120, the display 112 and the display 122. In another example embodiment, the rearview system configured to capture video data having different fields-of-capture includes the camera 110, the camera 120, the display 112, the display 122, and the processing circuit 1010. The processing circuit 1010 is configured to receive video data from the camera 110 and the camera 120 and to provide the video data to the display 112 and the display 122. The processing circuit 1010 is configured to provide the video data having a narrow-angle field-of-capture to a first portion of the display 112 and/or the display 122. The processing circuit 1010 is configured to provide the video data having a wide-angle field-of-capture to a second portion of the display 112 and/or the display 122.

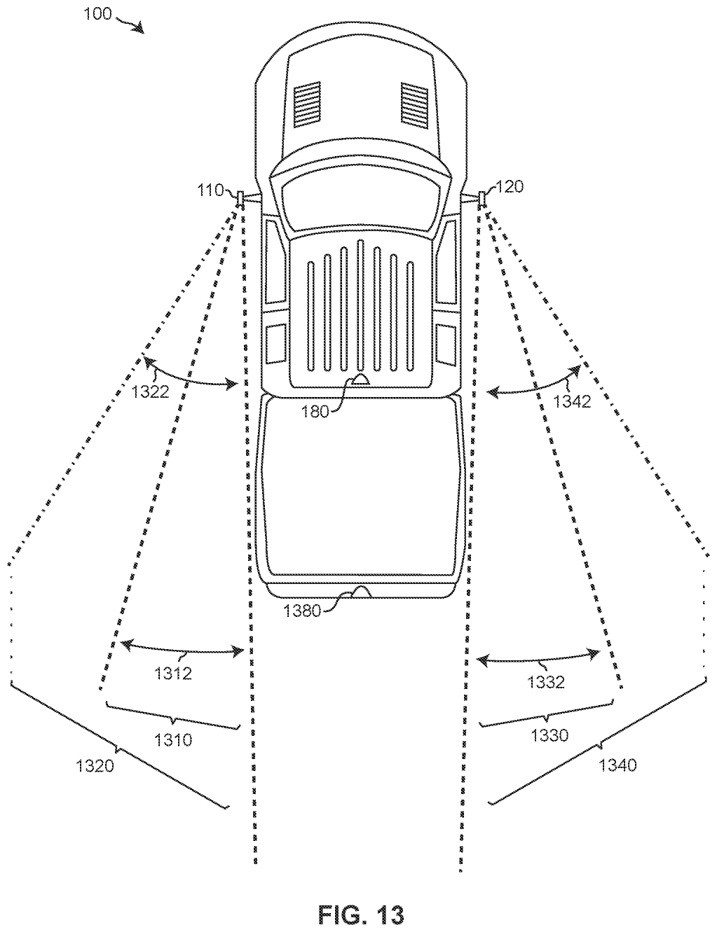

In an example embodiment, as best shown in FIG. 13, the camera 110 is configured to be mounted on a driver-side of the vehicle 100 and oriented rearward to capture a first video data and a second video data along the driver-side and rearward of the vehicle. The first video data has a narrow-angle field-of-capture 1310 and the second video data has a wide-angle field-of-capture 1320.

In an example embodiment, the narrow-angle field-of-capture 1310 is a portion of the wide-angle field-of-capture 1320. In an example embodiment, the narrow-angle field-of-capture 1310 is the portion of the wide-angle field-of-capture 1320 proximate to the vehicle 100. In an example embodiment, the narrow-angle field-of-capture 1310 extends away from the driver-side of the vehicle 100 at an angle 1312. The wide-angle field-of-capture 1320 extends away from the driver-side of the vehicle 100 at an angle 1322. In an example embodiment, the angle 1322 is greater than the angle 1312. In another example embodiment, the angle 1312 is about half of the angle 1322. In an example embodiment, the angle 1322 is about 90 degrees. In another example embodiment, the angle 1312 is about 30 degrees.

In an example embodiment, as best shown in FIG. 13, the camera 120 is configured to be mounted on a passenger-side of the vehicle 100 and oriented rearward to capture a third video data and a fourth video data along the passenger-side and rearward of the vehicle. The third video data has a narrow-angle field-of-capture 1330 and the fourth video data has a wide-angle field-of-capture 1340. In an example embodiment, the narrow-angle field-of-capture 1330 is a portion of the wide-angle field-of-capture 1340. In an example embodiment, the narrow-angle field-of-capture 1330 is the portion of the wide-angle field-of-capture 1340 proximate to the vehicle 100. In an example embodiment, the narrow-angle field-of-capture 1330 extends away from the driver-side of the vehicle 100 at an angle 1332. The wide-angle field-of-capture 1340 extends away from the driver-side of the vehicle 100 at an angle 1342. In an example embodiment, the angle 1342 is greater than the angle 1332. In an example embodiment, the angle 1332 is about half of the angle 1342. In an example embodiment, the angle 1342 is about 90 degrees. In another example embodiment, the angle 1332 is about 30 degrees.

The display 112 is configured to be mounted in the vehicle 100. The display 112 is configured to receive and present the first video data on a first portion of the display 112 and the second video data on a second portion of the display 112. The display 122 is configured to be mounted in the vehicle 100. The display 122 configured to receive and present the third video data on a third portion of the display 122 and the fourth video data on a fourth portion of the display 122.

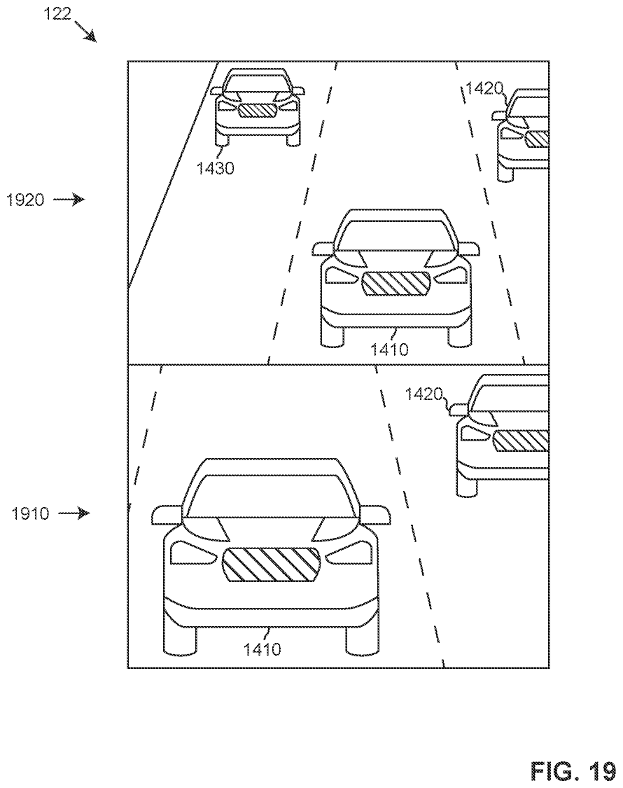

In an example implementation, as best seen in FIG. 19, the first portion of the display 112 comprises an upper portion 1920 of the display 112 and the second portion 1910 of the display 112 comprises a lower portion of the display 112. The third portion of the display 122 comprises an upper portion of the display 122, not shown and the fourth portion of the display 122 comprises a lower portion of the display 122, not shown. In another example implementation, the first portion of the display 112 comprises a left-hand portion of the display 112 and the second portion of the display 112 comprises a right-hand portion of the display 112. The third portion of the display 122 comprises a left-hand portion of the display 122 and the fourth portion of the display 122 comprises a right-hand portion of the display 122.

In an example embodiment, the display 112 is configured to be mounted toward the driver-side of the steering wheel of the vehicle 100. The display 122 is configured to be mounted toward the passenger-side of the steering wheel of the vehicle 100.

As best seen in FIG. 19, the video data from wide-angle field-of-capture may include the same viewpoint as the video data from the narrow-angle field-of-capture. However, the wide-angle field-of-capture data includes additional data that cannot be seen in the video data from the narrow-angle field-of-capture. For example, in an example embodiment, the video data from the narrow-angle field-of-capture does not include the blind spot on either the driver-site or the passenger-side of the vehicle 100. Whereas, the video data from the wide-angle field-of-capture does include the blind spot on either the driver-site or the passenger-side of the vehicle 100.

Afterword and Note Regarding Workpieces

The foregoing description discusses implementations (e.g., embodiments), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A rearview system for a first vehicle with collision detection, the rearview system comprising:
a detector configured to be mounted on the first vehicle and to detect an information regarding a second vehicle positioned rearward of the first vehicle;
a camera configured to be mounted on the first vehicle and oriented rearward to capture a video data rearward of the first vehicle, whereby the video data includes an image of the second vehicle;
a display configured to be mounted in the first vehicle, the display configured to receive and present the video data; and
a processing circuit configured to:
receive the information regarding the second vehicle;
determine a speed of the second vehicle and a position of the second vehicle relative to a speed of the first vehicle and a position of the first vehicle;
detect a potential collision between the second vehicle and the first vehicle; and
responsive to detecting the potential collision between the second vehicle and the first vehicle, present a warning on the display.

2. The rearview system of claim 1 wherein the processing circuit is further configured to:
receive a signal from a turn indicator; and
detect the potential collision between the second vehicle and the first vehicle if the first vehicle moves from a current lane to a driver-side lane or a passenger-side lane as indicated by the signal from the turn indicator.

3. The rearview system of claim 2 wherein the processing circuit is configured to present the warning on the display in accordance with whether the second vehicle is positioned in the driver-side lane or the passenger-side lane.

4. The rearview system of claim 3 wherein:
if the second vehicle is positioned in the passenger-side lane, the processing circuit presents the warning on a passenger-side portion of the display; and
if the second vehicle is positioned in the driver-side lane, the processing circuit presents the warning on a driver-side portion of the display.

5. The rearview system of claim 1 wherein the information detected by the detector includes at least one of the speed of the second vehicle, a position of the second vehicle, the position of the second vehicle relative to a lane, and acceleration of the second vehicle, and a deceleration of the second vehicle.

6. The rearview system of claim 1 wherein the warning comprises illuminating a portion of the display with a color.

7. The rearview system of claim 6 wherein the color comprises the color red.

8. The rearview system of claim 6 wherein illuminating comprises providing causing the portion of the display to flash the color.

9. The rearview system of claim 6 wherein the portion of the display comprises an outer portion around the display.

10. The rearview system of claim 6 wherein the portion of the display comprises an outer portion along a top of the display.

11. The rearview system of claim 6 wherein the portion of the display comprises an outer portion along a bottom of the display.

12. The rearview system of claim 1 wherein the warning comprises presenting the image of the second vehicle on the display as having a color.

13. A rearview system for a first vehicle with collision detection, the rearview system comprising:
a detector configured to be mounted on the first vehicle and to detect an information regarding a second vehicle positioned rearward of the first vehicle;
a first camera configured to be mounted on a driver-side of the first vehicle and oriented rearward to capture a first video data along the driver-side and rearward of the first vehicle;
a second camera configured to be mounted on a passenger-side of the first vehicle and oriented rearward to capture a second video data along the passenger-side and rearward of the first vehicle, at least one of the first video data and the second video data includes an image of the second vehicle;
a first display configured to be mounted toward the driver-side of a steering wheel of the first vehicle, the first display configured to receive and present the first video data;
a second display configured to be mounted toward the passenger-side of the steering wheel of the first vehicle, the second display configured to receive and present the second video data; and
a processing circuit configured to:
receive the information regarding the second vehicle;
determine a speed of the second vehicle and a position of the second vehicle relative to a speed of the first vehicle and a position of the first vehicle;
detect a potential collision between the second vehicle and the first vehicle; and
responsive to detecting the potential collision between the second vehicle and the first vehicle, present a warning on at least one of the first display and the second display.

14. The rearview system of claim 13 wherein the processing circuit is further configured to:
receive a signal from a turn indicator; and
detect the potential collision between the second vehicle and the first vehicle if the first vehicle moves from a current lane to a driver-side lane or a passenger-side lane as indicated by the signal from the turn indicator.

15. The rearview system of claim 14 wherein the processing circuit is configured to present the warning on the first display or the second display in accordance with whether the second vehicle is positioned in the driver-side lane or the passenger-side lane respectively.

16. The rearview system of claim 15 wherein:
if the second vehicle is positioned in the driver-side lane, the processing circuit presents the warning on the first display; and
if the second vehicle is positioned in the passenger-side lane, the processing circuit presents the warning on the second display.

17. The rearview system of claim 13 wherein the information detected by the detector includes at least one of the speed of the second vehicle, a distance of the second vehicle from the first vehicle, and a lane of travel of the second vehicle relative to the first vehicle.

18. The rearview system of claim 13 wherein the warning comprises illuminating a portion of at least one of the first display and the second display with a color.

19. The rearview system of claim 18 wherein the color comprises the color red.

20. The rearview system of claim 13 wherein the warning comprises presenting the image of the second vehicle on at least one of the first display and the second display as having a color.
